(19) United States
(12) Patent Application Publication
(10) Pub. No.: US 2019/0206171 A1
(43) Pub. Date: Jul. 4, 2019

(54) ENTRY/EXIT MANAGEMENT SYSTEM AND ENTRY/EXIT MANAGEMENT METHOD

(71) Applicant: Murata Manufacturing Co., Ltd., Nagaokakyo-shi (JP)

(72) Inventors: Jun Sasaki, Nagaokakyo-shi (JP); Katsumi Taniguchi, Nagaokakyo-shi (JP); Masaaki Kanao, Nagaokakyo-shi (JP); Tomohiro Furumura, Nagaokakyo-shi (JP); Ai Miyabayashi, Nagaokakyo-shi (JP)

(21) Appl. No.: 16/297,922

(22) Filed: Mar. 11, 2019

Related U.S. Application Data
(63) Continuation of application No. PCT/JP2018/027144, filed on Jul. 19, 2018.

(30) Foreign Application Priority Data
Jul. 21, 2017 (JP) 2017-142055

(51) Int. Cl. G07C 9/02; G07C 9/00; G06K 7/10

(52) U.S. Cl. CPC G07C 9/02; G06K 7/10366; G07C 9/00563; G07C 9/00182

(57) ABSTRACT

An entry/exit management system includes a reader at an entry gate for reading personal information of a user, a storage recording the read personal information, a database in which personal information for authentication is recorded in advance, and an authenticator for authenticating the recorded personal information by collation with the personal information for authentication recorded in the database. The entry/exit management system has a first operation mode in which the reader reads the personal information of the user to allow the entry gate to permit the entry of the user having the read personal information. In the first operation mode, after permitting the entry of the user, the authenticator authenticates the personal information recorded in the storage and does not give permission for exit of the user until the personal information recorded in the storage is successfully authenticated.

### CROSS REFERENCE TO RELATED APPLICATIONS

The present application is a continuation of PCT/JP2018/027144 filed Jul. 19, 2018, which claims priority to Japanese Patent Application No. 2017-142055, filed Jul. 21, 2017, the entire contents of each of which are incorporated herein by reference.

### TECHNICAL FIELD

The present invention relates to an entry/exit management system and an entry/exit management method in an area where entry/exit of a user is managed.

### BACKGROUND

An entry/exit management system conventionally manages entry/exit of a user to/from a controlled area through ID authentication at an entry gate and an exit gate. This improves the security of the controlled area. A user attempting to enter the entry gate holds an ID tag having ID information of the user recorded therein over (closer to) a reader for collation.

For example, in the system described in Patent Document 1 (identified below), a person ID of a visitor is read by a card reader disposed at an entry of a facility. The read person ID is compared with information stored in a database to determine whether entry to the facility is allowed. If it is determined that the entry is allowed, a gate device is opened to permit the entry.

FIG. 16 is a diagram showing a time passage of personal authentication at the time of entry in a conventional entry management method. At an entry gate, user's personal information is read and collated for one user at a time. Therefore, collation of personal information requires a reading time Tr and a collation time Tm of the personal information. After the elapse of time (Tr+Tm), if collated information matches, a first person can enter. Subsequently, the time (Tr+Tm) is also required for personal authentication of each of second and third persons.

Patent Document 1: Japanese Laid-Open Patent Publication No. 2004-318576.

If such personal authentication is successively performed for multiple users, the time required for the personal authentication of each user causes a delay in an authentication process, so that congestion may occur at the entry gate. Particularly, in the case of precise personal authentication, an information amount of personal information is large and therefore tends to cause congestion, increasing temporal and mental burdens of users. If the number of entry gates is increased to prevent the occurrence of congestion, costs are increased.

### SUMMARY OF THE INVENTION

It is therefore an object of the exemplary embodiments of the present invention to solve the problem described above of the conventional system and thus provide an entry/exit management system and an entry/exit management method relieving congestion at the time of entry.

To achieve the object, an exemplary aspect of the present invention provides an entry/exit management system managing entry/exit of a plurality of users into/from a management area through personal authentication. In this aspect, the system includes an entry gate restricting entry of a user into the management area; a reader disposed at the entry gate and reading personal information of the user; a storage recording the personal information read by the reader; a database in which personal information for authentication is recorded in advance; an authentication part for authenticating the personal information recorded in the storage by collation with the personal information for authentication recorded in the database; and an exit gate restricting exit of the user from the inside of the management area. Moreover, a controller is configured to operate the entry/exit management system in a first operation mode in which the reader reads the personal information of the user to allow the entry gate to permit the entry of the user having the read personal information, and wherein in the first operation mode, after allowing the entry gate to permit the entry of the user, the authentication part authenticates the personal information recorded in the storage and does not allow the exit gate to permit the exit of the user until the personal information recorded in the storage is successfully authenticated.

In another exemplary aspect of the present invention, an entry/exit management method is provided for managing entry/exit of a plurality of users into/from a management area through personal authentication. In this aspect, the method includes reading personal information of a user at an entry gate restricting entry into the management area; recording the read personal information; and authenticating the recorded personal information by collation with personal information for authentication recorded in advance in a database. In this aspect, the entry/exit management method has a first operation mode in which the personal information is read to permit the user having the read personal information to enter through the entry gate, wherein in the first operation mode, after permitting the user to enter through the entry gate, a step of authenticating the personal information is performed, and wherein the user is not permitted to exit through an exit gate until the personal information is successfully authenticated.

According to the entry/exit management system and the entry/exit management method of the present invention, congestion at the time of entry to an area managed by the system can be relieved as compared with conventional systems.

### BRIEF DESCRIPTION OF DRAWINGS

FIG. 1 is a schematic configuration diagram of an entry/exit management system according to a first exemplary embodiment.

FIG. 2 is a schematic diagram of an entry gate and an exit gate according to the first embodiment.

FIG. 3 is a block diagram showing a schematic configuration of an entry management system according to the first embodiment.

FIG. 4 is a flowchart showing a process procedure of an entry management method according to the first embodiment.

FIG. 5 is a flowchart showing a process procedure of the entry management method according to the first embodiment.

FIG. 6 is a diagram showing a time passage of personal authentication at the time of entry according to the first embodiment.

FIG. 7 is a schematic diagram of an entry gate and an exit gate according to a second exemplary embodiment.

FIG. 8 is a block diagram showing a schematic configuration of an entry management system according to the second embodiment.

FIG. 9 is a flowchart showing a process procedure of an entry management method according to the second embodiment.

FIG. 10 is a flowchart showing a process procedure of the entry management method according to the second embodiment.

FIG. 11 is a flowchart showing a process procedure of the entry management method according to the second embodiment.

FIG. 12 is a diagram showing a time passage of personal authentication at the time of entry according to the second embodiment.

FIG. 13 is a schematic configuration diagram of an entry/exit management system according to a third exemplary embodiment.

FIG. 14 is a block diagram showing a schematic configuration of an entry management system according to the third embodiment.

FIG. 15 is a schematic configuration diagram of a user position identification system according to the third embodiment.

FIG. 16 is a diagram showing a time passage of personal authentication at the time of entry according to a conventional example.

### DETAILED DESCRIPTION

An entry/exit management system according to an exemplary aspect of the present invention is an entry/exit management system for managing entry/exit of a plurality of users into/from a management area through personal authentication. In this aspect, the system includes an entry gate restricting entry of a user into the management area; a reader disposed at the entry gate and reading personal information of the user; a storage recording the personal information read by the reader; a database in which personal information for authentication is recorded in advance; an authentication part authenticating the personal information recorded in the storage by collation with the personal information for authentication recorded in the database; and an exit gate restricting exit of the user from the inside of the management area. Moreover, the system includes a controller for configuring the entry/exit management system to operate in a first operation mode in which the reader reads the personal information of the user to allow the entry gate to permit the entry of the user having the read personal information, and wherein in the first operation mode, after allowing the entry gate to permit the entry of the user, the authentication part authenticates the personal information recorded in the storage and does not allow the exit gate to permit the exit of the user until the personal information recorded in the storage is successfully authenticated.

According to this aspect, congestion at the time of entry can be relieved as compared with conventional systems.

Moreover, the entry/exit management system can further have a second operation mode in which the entry gate is allowed to permit the entry of the user having the read personal information when the read personal information is successfully authenticated, and the entry/exit management system may be configured to switch between the first operation mode and the second operation mode.

Two operation modes exist for personal authentication, and the overall authentication efficiency for entry and exit can be improved by switching the operation modes.

In an exemplary aspect, the entry/exit management system can further comprise a plurality of reader reading personal information of the user in the management area, and a position identification system identifying a position of the user in the management area based on the personal information read by the reader in the management area. As a result, even if the authentication of the personal information acquired at the time of entry is unsuccessful, the position of the unsuccessfully authenticated user can be identified within the management area, so that the unsuccessfully authenticated user can be caught.

In an exemplary aspect, the personal information can be biological information, and the reader may be a biological information reader. As a result, identity theft of the user can be prevented, and the security can further be increased.

In an exemplary aspect, the personal information can be ID information, and the reader may be an ID reader. As a result, the personal authentication can easily be performed.

In an exemplary aspect, the personal information can be biological information and RFID information, and the reader may include a biological information reader and an RFID reader. As a result, identity theft of the user can be prevented, and the security can further be increased.

In an exemplary aspect, the recorded personal information may be collated for a plurality of persons at a time with the personal information for authentication in the database. As a result, the recorded personal information and the personal information for authentication in the database can collectively be collated, and a collation time can be shortened.

In addition, an entry/exit management method according to an exemplary aspect of the present disclosure is provided for managing entry/exit of a plurality of users into/from a management area through personal authentication. In this aspect, the method includes reading personal information of a user at an entry gate restricting entry into the management area; recording the read personal information; and authenticating the recorded personal information by collation with personal information for authentication recorded in advance in a database. Moreover, according to the exemplary aspect, the entry/exit management method has a first operation mode in which the personal information is read so that the entry gate permits the entry of the user having the read personal information, wherein in the first operation mode, after the entry gate permits the entry of the user, a step of authenticating the personal information is performed, and wherein the user is not permitted to exit from an exit gate until the personal information is successfully authenticated.

According to this aspect, congestion at the time of entry can be relieved.

In an exemplary aspect, the entry/exit management method can include a second operation mode in which the user having the read personal information is permitted to enter through the entry gate when the read personal information is successfully authenticated, and the first operation mode and the second operation mode may be switched.

Furthermore, two operation modes exist for personal authentication, and the overall authentication efficiency for entry and exit can be improved by switching the operation modes.

In an exemplary aspect, the entry/exit management method can include reading personal information of the user by a plurality of readers reading personal information of the user disposed in the management area, and a position of the user in the management area may be identified based on the personal information read by the readers disposed in the management area. As a result, even if the authentication of the personal information acquired at the time of entry is unsuccessful, the position of the unsuccessfully authenticated user can be identified within the management area, so that the unsuccessfully authenticated user can be caught.

In an exemplary aspect, the personal information can be biological information, and for the reading of the personal information, the biological information can be read. As a result, identity theft of the user can be prevented, and the security can further be increased.

In an exemplary aspect, the personal information can be ID information, and at the step of reading the personal information, the ID information may be read. As a result, the personal authentication can easily be performed.

In an exemplary aspect, the personal information can be biological information and RFID information, and at the step of reading the personal information, the biological information and the RFID information may be read. As a result, identity theft of the user can be prevented, and the security can further be increased.

In an exemplary aspect, the recorded personal information can be collated for a plurality of persons at a time with the personal information for authentication in the database. As a result, the recorded personal information and the personal information for authentication in the database can collectively be collated, and a collation time can be shortened.

Exemplary embodiments of the present invention will now be described with reference to the drawings.

### First Embodiment

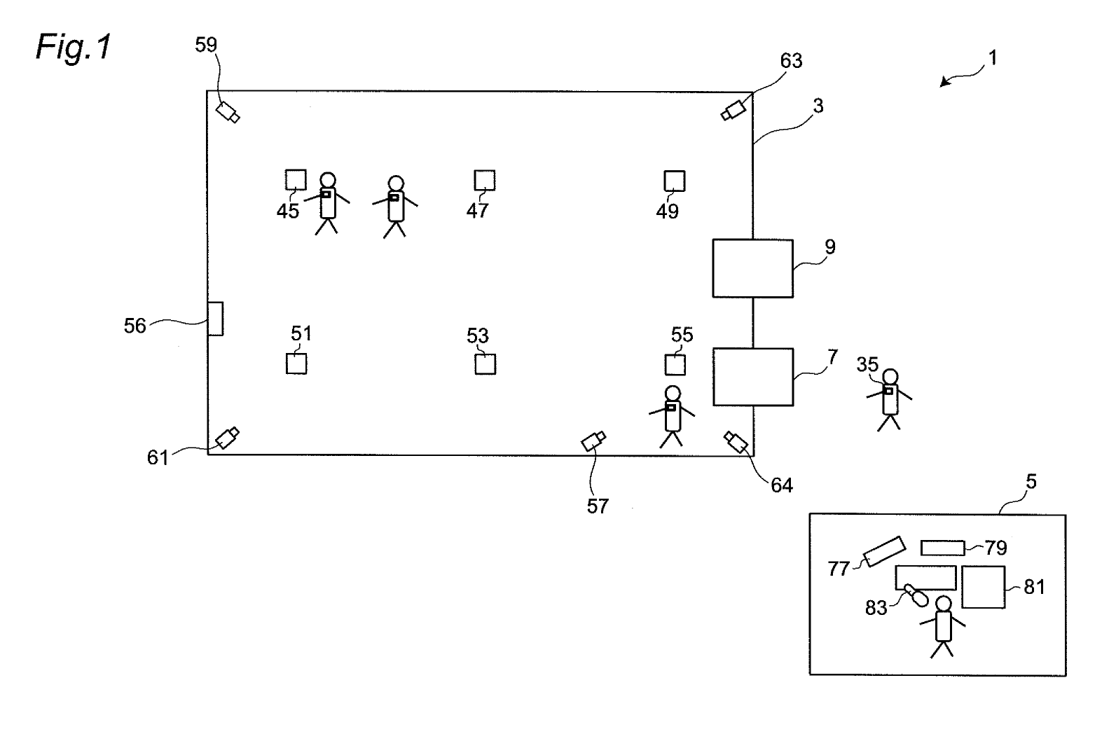

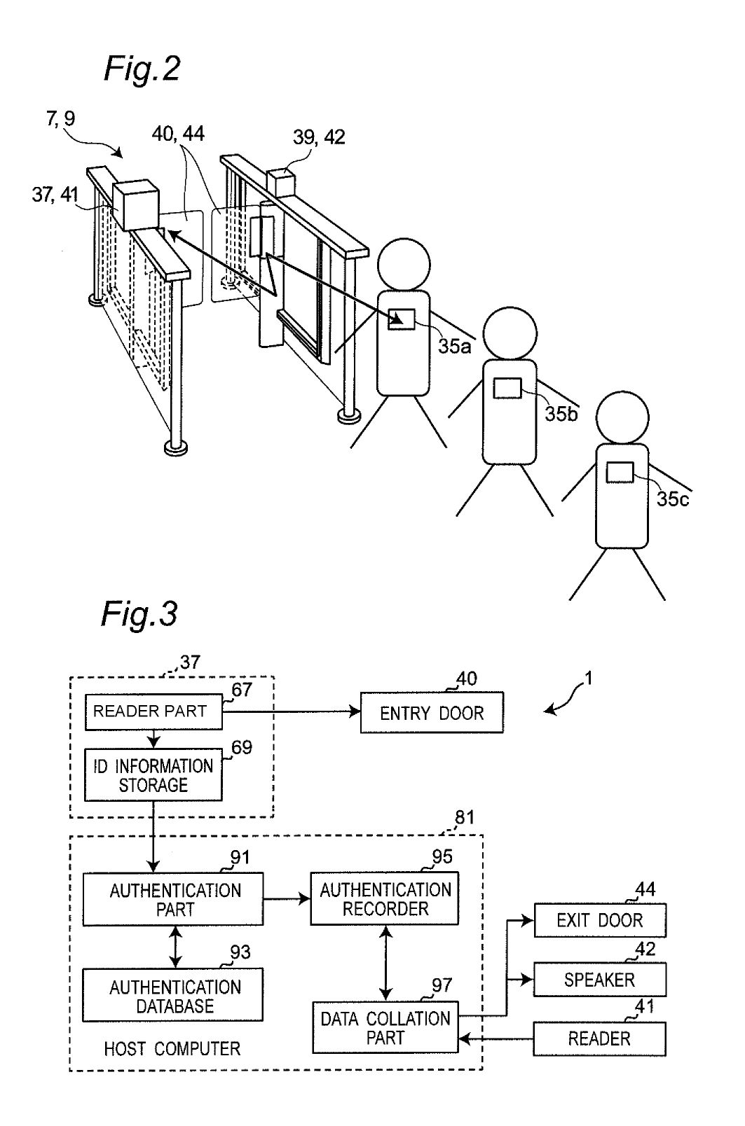

An entry/exit management system and an entry/exit management method according to a first exemplary embodiment of the present disclosure will hereinafter be described. FIG. 1 is a schematic configuration diagram of an entry/exit management system according to the first embodiment. FIG. 2 is a schematic diagram of an entry gate and an exit gate. According to the exemplary aspect, an entry/exit management system 1 is configured to manage entry/exit of a user to/from a management area 3. Therefore, the management area 3 is an area where entry/exit of a user is managed. A status of entry/exit of a user to/from the management area 3 can be confirmed in a monitoring room 5, which can be a separate location from the management area 3, for example. The entry to the management area 3 is restricted by an entry gate 7. The exit from the management area 3 is also restricted by an exit gate 9. Examples of the management area 3 can include schools, companies, airport terminals, and the like.

Description will be now made with reference to FIG. 2. Although the entry gate 7 and the exit gate 9 have the same schematic configuration in the first embodiment and are therefore shown in FIG. 2 as the same gate, different functions for each of the entry and exit gates will be described below. In the exemplary embodiment, the entry gate 7 is provided with a reader 37 configured to read tag ID information of RFID (Radio Frequency Identification) tags 35a, 35b, 35c possessed (e.g., carried) by users, an entry door 40, and a speaker 39. The reader serving as a reader is configured to read the tag ID information of the user approaching the entry gate 7. The tag ID information includes a tag ID number. The RFID tags 35a, 35b, 35c are collectively referred to as an RFID tag 35.

For the RFID tag 35, a passive RFID tag in the UHF band is used. It should be appreciated that another wireless tag may be used instead of the RFID tag. Instead of a passive wireless tag, an active wireless tag may be used. Wireless communication standards such as the HF band, Wi-Fi (registered trademark), Bluetooth (registered trademark), BLE (Bluetooth Low Energy), and the like, can be used according to variations of the exemplary aspect.

The exit gate 9 is also provided with a reader 41 reading the tag ID information of the RFID tags 35 possessed by the users, an exit door 44, and a speaker 42. The reader 41 is configured to read the tag ID information of a person exiting the management area 3. Although the exit gate 9 is disposed separately from the entry gate 7 in the first embodiment, an entry/exit gate may be disposed by integrating the entry gate 7 and the exit gate 9.

Description will be now made with reference to FIG. 1 again. In the management area 3, readers 45, 47, 49, 51, 53, 55 reading the RFID tags 35 of the users in the area are disposed on a ceiling of a passageway, for example, and a speaker 56 for broadcasting voice guidance from the monitoring room 5 is also included. The management area 3 is also provided with cameras 57, 59, 61, 63, 64 capturing images of the users. The readers 37, 41, 45, 47, 49, 51, 53, 55 may have not only the function of reading the ID information of the RFID tag 35 but also a function of being configured to write data to each users RFID tag 35.

Each of the readers is configured to transmit toward a surrounding space thereof a request signal for transmission of tag ID information. When receiving the request signal, the RFID tag 35 transmits the tag ID information. The transmitted tag ID information is received by the reader, and the presence of the RFID tag 35 can be detected.

The monitoring room 5 is provided with a monitor 77 configured to constantly display images captured by the cameras 57, 59, 61, 63, 64, a monitor 79 displaying the image of the camera specified by a surveillant, a host computer 81 performing collation for entry/exit of a user, and a microphone 83 connected to the speaker 56 in the management area 3.

FIG. 3 is a block diagram showing a schematic configuration of an entry management system according to the first embodiment. The reader 37 includes a reader part 67 (e.g., RFID tag reader) configured to read the tag ID information of the RFID tag 35 and an ID information storage 69 configured to record the read tag ID information. The host computer 81 includes an authentication part 91 (i.e., an “authenticator”), an authentication database 93, an authentication recorder 95, and a data collation part 97. In the example described in this embodiment, the ID information storage 69 serving as a storage is included in the reader 37; however, the present invention is not limited thereto. The ID information storage 69 may be included in the host computer 81 in an alternative aspect.

The entry/exit management system. 1 according to the first embodiment includes the RFID tag 35, the readers 37, 41, the entry door 40, the exit door 44, and the host computer 81. In this aspect, these devices form the entry/exit management system 1 and are wired or wirelessly connected to the host computer 81 and are configured to transmit and receive data.

The reader part 67 of the reader 37 is configured to read the tag ID information and then records the read tag ID information in the ID information storage 69. When the reader part 67 reads the tag ID information, the reader part 67 sends an entry permission signal to the entry door 40. When receiving the entry permission signal, the entry door 40 opens the door. In the example described in this embodiment, the reader part 67 transmits the entry permission signal to the entry door 40. However, it is noted that the present invention is not limited thereto and in an alternative aspect the host computer 81 can be configured to transmit the entry permission signal.

When the tag ID information is recorded for a predetermined number of persons, the ID information storage 69 collectively transmits these pieces of information to the host computer 81 in a batch transmission, for example. In the first embodiment, for example, the tag ID information is transmitted for every N persons to the host computer 81, where N is a natural number of 2 or more and can be set by a system administrator, for example. The tag ID information may be transmitted collectively for N persons in this way or may be transmitted for each person.

The authentication part 91 collates the tag ID information transmitted to the host computer 81 with the authentication database 93. In the authentication database 93 serving as a database, the tag ID information for permitting the entry through the entry gate 7 is recorded in advance. The authentication part 91 outputs a result of “matching” when the read tag ID information matches the tag ID information of the database, or outputs a result of “mismatching” in the case of mismatching, together with the collated tag ID information to the authentication recorder 95. The authentication by the authentication part 91 can be performed for each person or can be performed as a batch collation process for N persons according to exemplary aspects.

When the tag ID information of the N persons is collectively authenticated with the authentication database 93, the authentication part 91 can perform the authentication from a predetermined time. For example, the authentication can be performed 30 minutes after the end of a lunch break. If the reader 37 does not detect the RFID tag 35 for a certain period of time, the reader 37 may transmit an authentication instruction to the authentication part 91, and the authentication part 91 may start collation in accordance with this authentication instruction.

The authentication recorder 95 records a result of collation between the tag ID information transmitted to the host computer 81 and the tag ID information registered in the authentication database 93 in correlation with the transmitted tag ID information.

The reader 41 of the exit gate 9 reads the tag ID information of the exiting person approaching the exit gate 9 and then transmits the read tag ID information to the host computer 81.

The data collation part 97 inquires (i.e., queries) the authentication recorder 95 about the tag ID information of the exiting person transmitted to the host computer 81. If the tag ID information of the exiting person is recorded as the result of “matching” in the authentication recorder 95, an exit permission signal is output to the exit door 44. If the tag ID information of the exiting person is recorded as the result of “mismatching”, the data collation part 97 transmits a warning signal to the speaker 42 of the exit gate 9. When receiving the warning signal, the speaker 42 emits a warning sound. In the case of “mismatching”, the data collation part 97 displays a warning on the monitor 79 of the monitoring room 5 and notifies the surveillant (i.e., the person or administrator in the monitoring room 5) of the presence of a suspicious person.

According to an exemplary aspect, the authentication part 91 and the data collation part 97 can be comprised of one or more of a plurality of CPUs, microprocessors, or FPGAs (Field Programmable Gate Arrays) or may be integrated into one CPU, microprocessor, or FPGA, each of which are configured to execute the algorithms disclosed herein. The ID information storage 69, the authentication database 93, and the authentication recorder 95 may each be made up of a plurality of hard disks, memories, or SSDs (Solid State Drives). The ID information storage 69, the authentication database 93, and the authentication recorder 95 may be integrated into one hard disk, memory, or SSD.

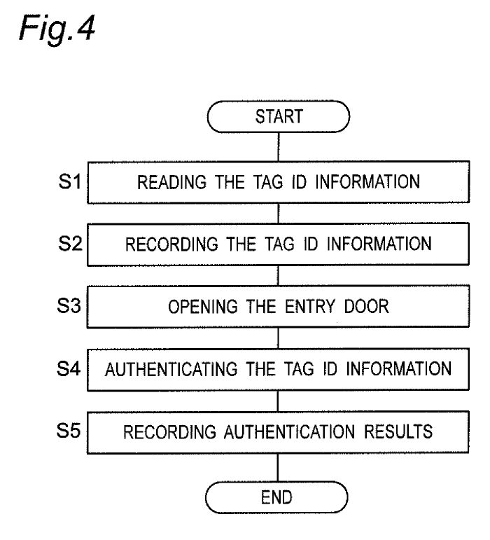

The entry/exit management method according to an exemplary aspect will now be described with reference to FIG. 4. FIG. 4 is a flowchart showing a process procedure of the entry/exit management method. The process procedure is roughly divided into two processes, i.e., a process of authenticating a user at the time of entry and a process of performing authentication at the time of exit. First, the process related to authentication of a user at the time of entry will be described with reference to FIG. 4.

When the user approaches the entry gate 7 from outside the management area 3, the reader part 67 of the reader 37 reads the tag ID information of the RFID tag 35 possessed by the user (step S1). The read tag ID information is recorded in the ID information storage 69 in correlation with the reading time and the ID information of the reader 37 that has read the information (step S2). When the tag ID information is normally read, the reader part 67 transmits an entry permission signal to the entry door 40. Upon receiving the entry permission signal, the entry door 40 opens the door (step S3). A requirement for occurrence of step S3 is step S1 only, and the timings of occurrence of step S2 and step S3 may be inverted. When the number of persons having the tag ID information recorded in the ID information storage 69 reaches the predetermined number N, the tag ID information of N persons as well as the respective reading times and the ID information of the reader 37 correlated thereto are transmitted from the ID information storage 69 to the authentication part 91 of the host computer 81. As used herein, the phrase “the tag ID information is normally read” means that, for example, the reader part 67 acquires a reading count number equal to or greater than a certain number within a predetermined time. This count number may be recorded as contents to be recorded in the ID information storage 69.

In the host computer 81, the authentication part 91 receives tag ID information of N persons. The authentication part 91 authenticates the tag ID information of N persons by collation with the personal information recorded in the authentication database 93 (step S4) and records authentication results as to whether matching is achieved in the collation of each pieces of the information, in correlation with the tag ID information, into the authentication recorder 95 (step S5). This leads to the end of the authentication process at the time of entry.

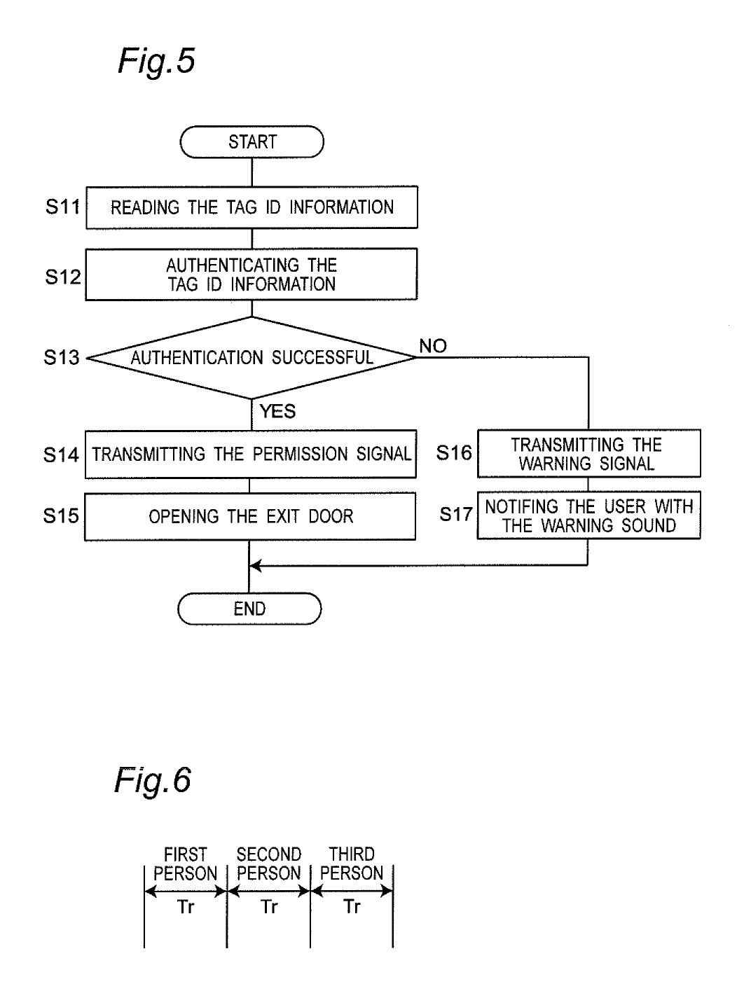

A process of performing authentication at the time of exit will be described with reference to FIG. 5. FIG. 5 is a flowchart showing a process procedure of the entry/exit management method.

According to this exemplary aspect, when a user approaches the exit gate 9 in the management area 3, the reader 41 reads the tag ID information of the RFID tag 35 possessed by the user (step S11). The read tag ID information is transmitted to the data collation part 97 of the host computer 81 in correlation with the reading time and the ID information of the reader 41 that has read the information.

In the host computer 81, the data collation part 97 receives the tag ID information sent from the exit gate 9. The data collation part 97 authenticates the received tag ID information by collation with the authentication result of the tag ID information read at the time of entry recorded in the authentication recorder 95 (step S12). If the authentication is successful with respect to the tag ID information received by the data collation part 97 due to matching in the collation with the tag ID information read at the time of entry (Yes at step S13), an exit permission signal is transmitted to the exit door 44 of the exit gate 9 (step S14). In the exit gate 9, when the exit door 44 receives the exit permission signal, the exit door 44 is opened (step S15), and the exiting person can exit to the outside of the management area 3.

At step S13, if the authentication is not successful with respect to the tag ID information received by the data collation part 97 in the case of mismatching in the collation at the time of entry or since the collation at the time of entry is not yet completed so that the collation result is not recorded in the authentication recorder 95 (No at step S13), a warning signal is transmitted to the speaker 39 of the entry gate 7 (step S16). Upon receiving the warning signal, the speaker 42 of the exit gate 9 notifies the user with the warning sound (step S17) according to an exemplary aspect. In this case, since the exit door 44 does not receive the exit permission signal, the exit door 44 is not opened and the user for that RFID tag 35 is not permitted to exit the management area 3, for example.

According to the first embodiment, the entry/exit management system 1 includes the entry gate 7, the reader 37, the ID information storage 69, the authentication database 93, the authentication part 91, and the exit gate 9. The entry/exit management system 1 has a first operation mode in which the reader 37 reads the personal information of the user to allow the entry gate 7 to permit the entry of the user having the read personal information. After allowing the entry gate 7 to permit the entry of the user in the first operation mode, the authentication part 91 authenticates the personal information recorded in the ID information storage 69 and does not allow the exit gate 9 to permit the exit of the user until the personal information recorded in the ID information storage 69 is successfully authenticated. As a result, the user can enter the inside of the management area 3 when the reading and recording of the tag ID information is completed at the time of entry, so that the time of personal authentication at the time of entry can be shortened by a collation time in the authentication time of the tag ID information. As shown in FIG. 6, the time of personal authentication required for each entering person at the time of entry may be substantially only a reading time Tr of the ID information tag. Although a user possessing the RFID tag 35 unauthorized to enter can also pass through the entry gate 7 when the reading of the tag ID information is completed, the user possessing the RFID tag 35 unauthorized to enter cannot pass through the exit gate 9 in the collation at the time of exit. Additionally, when the user possessing the RFID tag 35 unauthorized to enter attempts to pass through the exit gate 9, a warning sound can be emitted from the speaker 42, so that other persons therearound can be notified of the presence of the user unauthorized to enter at the exit gate 9. In this way, the time of personal authentication at the time of entry can be reduced, and the user having entered the inside of the management area 3 without authority can be caught at the exit gate 9.

In the first embodiment, the tag ID information using the RFID tag 35 is employed as the personal information for authentication. However, it is noted that the present invention is not limited thereto. For example, biological information may be used as the personal information for authentication. In the case of using biological information, a data amount is large, and it takes time to collate biological information of each user, so that the effect in the first embodiment becomes more prominent.

If biological information is used as the personal information for authentication, a reader reading biological information is employed as the reader 37. The authentication database 93 has the biological information of users authorized to enter recorded in advance. The biological information is information unique to a living body and is information that can identify a person. A vein pattern of a finger or a palm of a hand, a retina, a voice print, or the like, can be used as the biological information.

### Second Embodiment

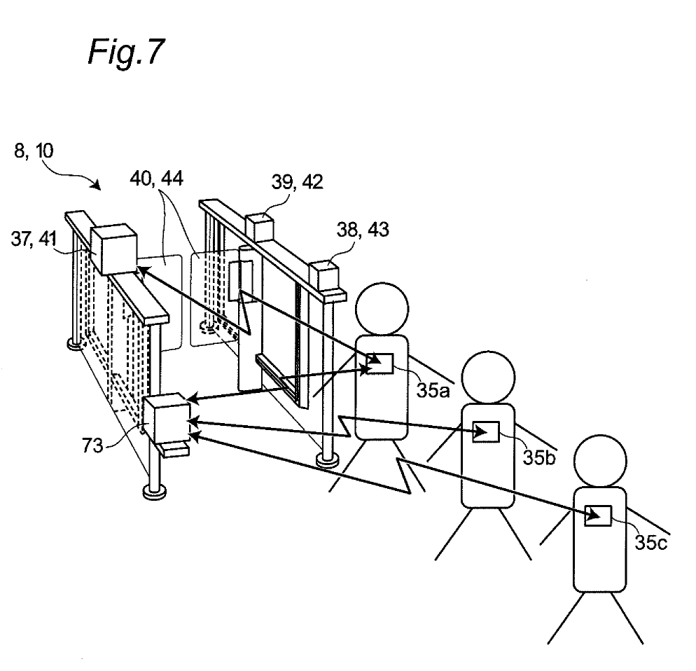

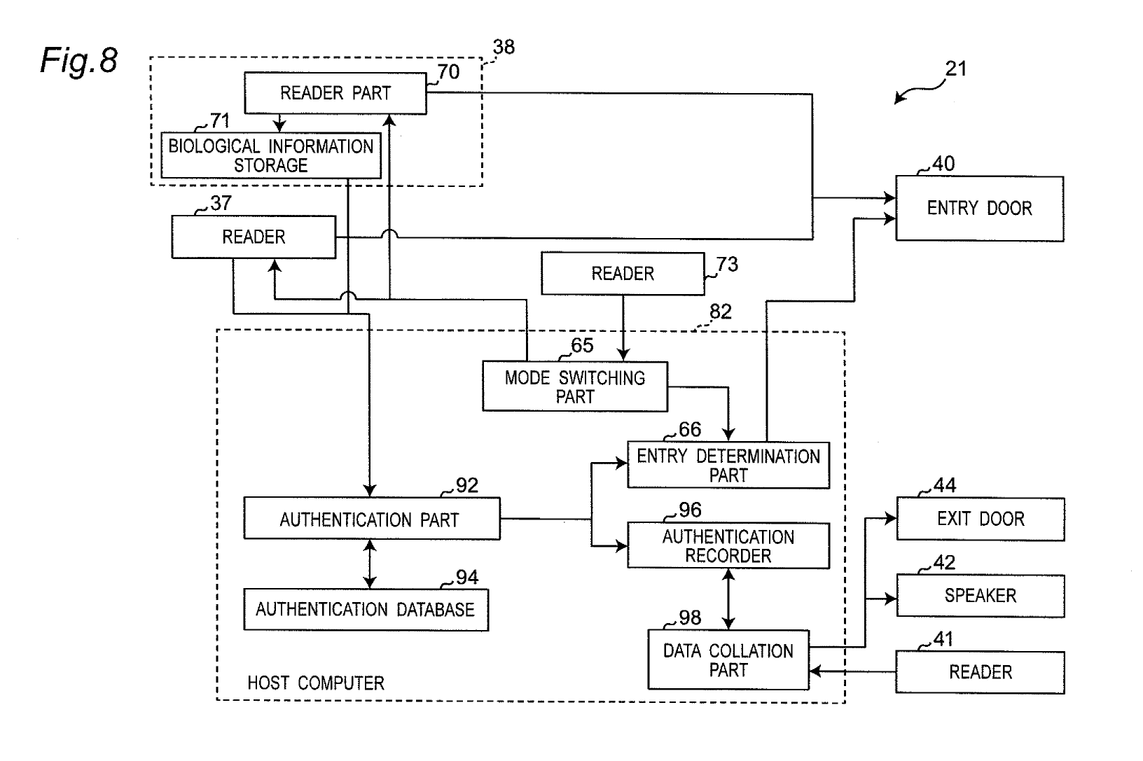

An entry/exit management system and an entry/exit management method according to a second exemplary embodiment of the present disclosure will be described with reference to FIGS. 7 and 8. The entry/exit management system 1 according to the first embodiment uses one type of personal information for authentication, while an entry/exit management system 21 according to the second embodiment uses two types of personal information for authentication. Additionally, the entry/exit management system 21 according to the second embodiment has two operation modes for operation modes of personal authentication. The two operation modes are a first operation mode that is the operation mode of the first embodiment in which the entry gate 8 is opened by merely acquiring personal information and a second operation mode in which the entry gate 8 is opened after acquisition and authentication of personal information. In the entry/exit management system 21 according to the second embodiment, the configurations other than the matters described below are the same as the entry/exit management system 1 of the first embodiment.

FIG. 7 is a schematic diagram of an entry gate and an exit gate according to the second embodiment. An entry gate of the second embodiment further includes a biological information reader 38 and a reader 73 reading the tag ID information of the RFID tag 35 separately from the reader 37 in the entry gate 7 of the first embodiment. An exit gate 10 of the second embodiment further includes a biological information reader 43 in the exit gate 9 of the first embodiment.

The biological information reader 38 serving as a reader includes a reader part 70 configured to read biological information of a user and a biological information storage 71 recording the read biological information. In the second embodiment, the reader part 70 reads, for example, a user's finger vein pattern as the biological information. The read biological information is collectively transmitted for N persons to the authentication part 92.

FIG. 8 is a schematic configuration diagram of the entry/exit management system according to the second embodiment. A host computer 82 includes an authentication part 92 (i.e., an “authenticator”), an authentication database 94, an authentication recorder 96, a data collation part 98, a mode switching part 65, and an entry determination part 66. In the example described in the second embodiment, the biological information storage 71 is included in the biological information reader 38. However, it is noted that the present invention is not limited thereto. The biological information storage 71 may be included in the host computer 82.

The authentication part 92 is configured to collate the tag ID information and the biological information transmitted to the host computer 82 with the authentication database 94. In the authentication database 94, tag ID information and the biological information of a user allowed to enter through the entry gate 8 are recorded in a correlated manner in advance. The authentication part 92 outputs a result of “matching” when the read tag ID information and the biological information match the tag ID information and the biological information of the authentication database 94, or outputs a result of “mismatching” in the case of mismatching, together with the tag ID information to the authentication recorder 96 and the entry determination part 66.

The authentication recorder 96 records a result of collation in the authentication part 92 in correlation with the tag ID information.

The reader 41 of the exit gate 10 reads the tag ID information of the user at the exit gate 10 and then transmits the read tag ID information to the host computer 82.

The data collation part 98 inquires the authentication recorder 96 about the tag ID information of the exiting person transmitted to the host computer 82. If the tag ID information of the exiting person has the result of “matching” in the authentication recorder 96, an exit permission signal is output to the exit door 44. If the tag ID information of the exiting person has the result of “mismatching”, the data collation part 98 transmits a warning signal to the speaker 42 of the exit gate 10. When receiving the warning signal, the speaker 42 emits a warning sound. In the case of “mismatching”, the data collation part 98 displays a warning on the monitor 79 of the monitoring room 5 and notifies the surveillant of the presence of a suspicious person.

The mode switching part 65 (i.e., the “mode” or “function” switcher) is configured to switch the operation mode of personal authentication at the time of entry to either the first operation mode or the second operation mode. The first operation mode is an operation mode in which the entry gate 8 allows entry when the personal information is merely read at the time of entry. The second operation mode is an operation mode in which the entry gate 8 allows entry when the personal information is read at the time of entry and matching is achieved as a result of personal authentication in the host computer 8.

The timing of switching of the operation mode between the first operation mode and the second operation mode may be a predetermined time and/or may be set by an administrator of the system. In an exemplary aspect, a crowded time zone for entering users is preferable for an operation time in the first operation mode. Examples thereof include a time zone from 30 minutes before a start time of a school or a company to the start time and a time zone from 30 minutes after a lunch break to the end of the lunch break. Instead of switching the operation mode at a specified time, the operation mode may be switched depending on the number of users standing in line for the entry gate 7. Alternatively, the operation mode may be switched by the surveillant giving an instruction for switching to the host computer 81, for example.

In another example, in FIG. 7, a plurality of users is standing in line for the entry gate 8. The entry gate 8 is provided with the reader 73 reading the tag ID information of the users standing in line for the entry gate 8, separately from the reader 37 disposed for authentication of the personal information at the time of entry. The reader 73 periodically reads the tag ID information and sends the number of pieces of the read tag ID information to the mode switching part 65 of the host computer 82. The reading is configured to be periodically performed at intervals of several seconds to several minutes.

The mode switching part 65 is then configured to switch the operation mode depending on the number of pieces of the tag ID information periodically sent from the reader 73. Specifically, if the number of pieces of the tag ID information is equal to or greater than a predetermined number D, the personal authentication at the entry gate 8 is performed in the first operation mode, and if the number of pieces of the tag ID information is less than D, the personal authentication at the entry gate 8 is performed in the second operation mode. D may be set to an arbitrary number that is a natural number of 2 or more and may further be set by a system administrator, for example.

If the personal authentication is performed in the first operation mode, the mode switching part 65 instructs the reader 37 to transmit the entry permission signal to the entry door 40 after reading the tag ID information. The mode switching part 65 also instructs the biological information reader 38 to transmit the entry permission signal to the entry door 40 after reading the biological information. Upon receiving the entry permission signals from both the reader 37 and the biological information reader 38, the entry door 40 opens and permits the respective user to enter the management area 3. In the example described in the second embodiment, the entry permission signal is transmitted to the entry door 40 by the reader 37 and the biological information reader 38; however, the present invention is not limited thereto. The host computer 82 can be configured to transmit the entry permission signal according to an alternative aspect.

If the personal authentication is performed in the second operation mode, the mode switching part 65 instructs the reader 37 and the biological information reader 38 to terminate the transmission of the entry permission signal to the entry door 40. Moreover, the mode switching part 65 also instructs the entry determination part 66 to operate in the second operation mode.

In the second operation mode, the entry determination part 66 transmits the entry permission signal to the entry door 40 when the collation result of the authentication part 92 is a “matching” result. Alternatively, when the collation result of the authentication part 92 is a “mismatching” (or no match) result, the entry determination part 66 transmits the warning signal to the speaker 39 of the entry gate 8 and the respective user is not permitted to enter the management area 3. The entry determination part 66 does not operate in the first operation mode.

Regardless of whether the first operation mode or the second operation mode, the collation of the RFID tag 35 and the biometric authentication may further be performed as the personal authentication at the time of exit.

As noted above, the authentication part 92, the data collation part 98, the mode switching part 65, and the entry determination part 66 can be comprises of a plurality of CPUs, microprocessors, or FPGAs, or may be integrated into one CPU, microprocessor, or FPGA. The ID information storage 69, the biological information storage 71, the authentication database 94, and the authentication recorder 96 may be made up of hard disks, memories, or SSDs. The ID information storage 69 and the biological information storage 71 may be integrated into one hard disk, memory, or SSD. The authentication database 94 and the authentication recorder 96 may be integrated into one hard disk, memory, or SSD.

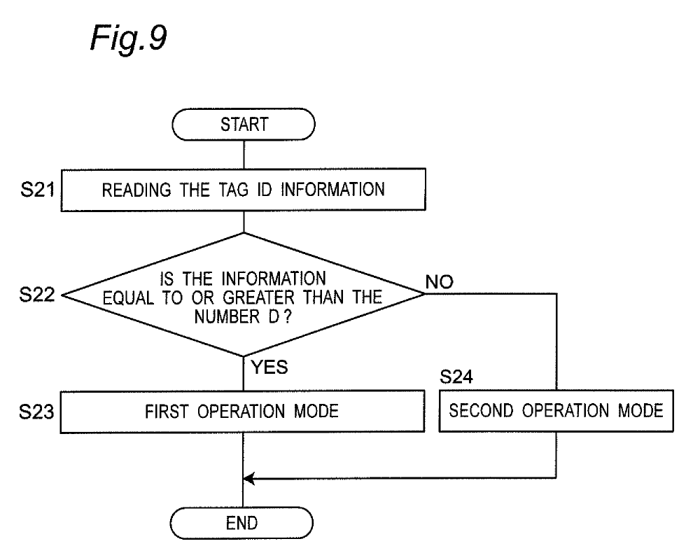

The entry/exit management method will be described with reference to FIG. 9. In the second embodiment, two types of operation modes exist for the personal authentication at the entry gate. A flow of selection of the operation modes will be described. FIG. 9 is a flowchart showing a process procedure of switching the operation modes.

The switching of the operation mode will be described with an example of switching depending on the number of users standing in line for the entry gate 8 although the switching depending on a time zone has been also given as an example. The reader 73 disposed on the entry gate 8 reads the tag ID information of the RFID tags of the users standing in line for the entry gate 8. For example, in the example shown in FIG. 7, the tag ID information of the RFID tags 35a, 35b, 35c is read (step S21).

In this aspect, the reader 73 counts the number of pieces of the read tag ID information. Since the pieces of the tag ID information of the RFID tags 35a, 35b, 35c are read at step S21, the counted number of pieces of tag ID information is three.

The counted number is transmitted from the reader 73 to the mode switching part 65 of the host computer 82.

The mode switching part 65 of the host computer 82 receives the number “3”, which indicates the counted number of pieces of the tag ID information. The mode switching part 65 determines whether the number of pieces of the tag ID information is equal to or greater than the predetermined number D (step S22). In the second embodiment, for example, D is set to “3”.

If the number of pieces of tag ID information is equal to or greater than the predetermined number D (YES at step S22), the mode switching part 65 is configured to select the first operation mode (step S23). Moreover, the mode switching part 65 is configured to instruct the reader 37, the biological information reader 38, and the entry determination part 66 to operate in the first operation mode. In the example of FIG. 7, the personal authentication at the time of entry is performed in the first operation mode.

If the number of pieces of tag ID information is not equal to or greater than the predetermined number D (NO at step S22), the mode switching part 65 is configured to select the second operation mode (step S24). The mode switching part 65 instructs the reader 37, the biological information reader 38, and the entry determination part 66 to operate in the second operation mode. This leads to the end of the flow of switching the operation modes.

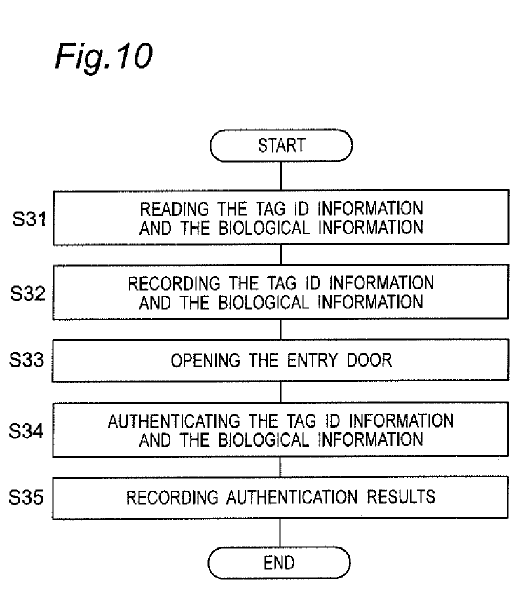

A process related to the personal authentication at the time of entry in the first operation mode will be described with reference to FIG. 10. FIG. 10 is a flowchart showing a process procedure of the entry/exit management method.

When a user approaches the entry gate 8 from outside the management area 3, the reader part 67 of the reader 37 reads the tag ID information of the RFID tag 35 possessed by the user. When the user holds the index finger over (e.g., closer to) the reader part 70 of the biological information reader 38, the reader part 70 reads the vein pattern of the user's finger (step S31). The read tag ID information is recorded in the ID information storage 69 in correlation with the reading time and the ID information of the reader 37 that has read the information. The read biological information is recorded in the biological information storage 71 in correlation with the reading time and the ID information of the biological information reader 38 that has read the information (step S32).

Upon reading the tag ID information, the reader part 67 is configured to transmit the entry permission signal to the entry door 40. Upon reading the biological information, the reader part 70 transmits the entry permission signal to the entry door 40. Upon receiving both entry permission signals, the entry door 40 opens (step S33). A requirement for occurrence of step S33 is step S31 only, and the timings of occurrence of step S32 and step S33 may be inverted. When the number of persons having the tag ID information and the biological information recorded in the ID information storage 69 and the biological information storage 71 reaches the predetermined number N, the tag ID information and the biological information of N persons as well as the respective reading times and the respective pieces of the ID information of the reader 37 and the biological information reader 38 correlated thereto are transmitted from the ID information storage 69 and the biological information storage 71 to the authentication part 91 of the host computer 81.

In the host computer 81, the authentication part 92 receives the tag ID information and the biological information of N persons. The authentication part 92 authenticates the tag ID information and the biological information of N persons by collation with the personal information recorded in the authentication database 94 (step S34) and records authentication results as to whether matching is achieved in the collation, in correlation with the tag ID information, into the authentication recorder 96 (step S35). This leads to the end of the authentication process at the time of entry.

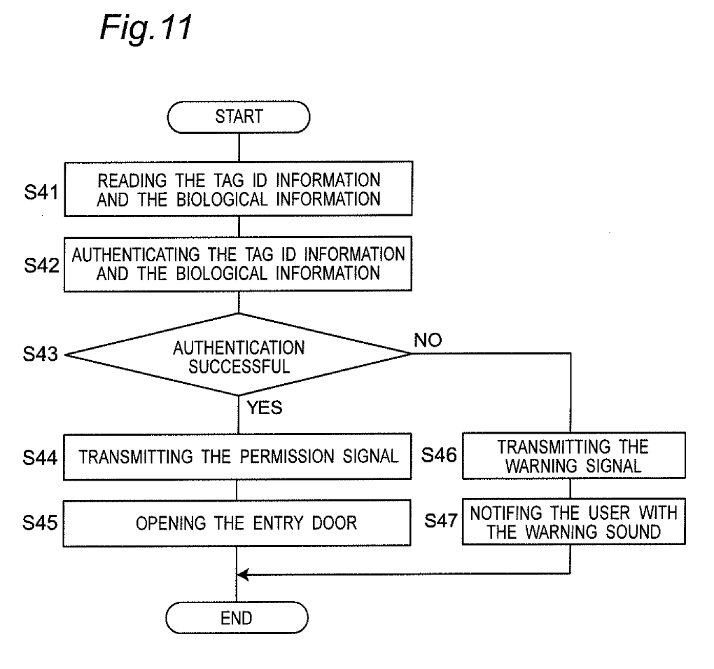

A process related to the authentication at the time of entry of a user in the second operation mode will be described with reference to FIG. 11.

The reading of the tag ID information of the RFID tag 35 possessed by the user and the reading of the biological information (step S41) are the same as step S31 of the first operation mode. The read tag ID information is transmitted to the host computer 82 in correlation with the reading time and the ID information of the reader 37 that has read the information. The read biological information is transmitted to the host computer 82 in correlation with the reading time and the ID information of the biological information reader 38 that has read the information. In the host computer 82, the authentication part 92 receives the transmitted tag ID information and biological information. The authentication part 92 authenticates the received tag ID information and the biological information by collation with tag ID information and biological information authorized for entry stored in the authentication database 94 (step S42).

If the authentication of step S42 is successful due to matching in the collation (YES at step S43), the authentication part 92 transmits a successful result of the authentication to the entry determination part 66. Upon receiving the successful result of the authentication, the entry determination part 66 transmits the entry permission signal to the entry door 40 of the entry gate 8 (step S44). In the entry gate 8, when the entry door 40 receives the entry permission signal from the entry determination part 66, the entry door 40 is opened (step S45), and the user can enter the inside of the management area 3.

If the authentication is not successful due to mismatching in the collation of step S42 (NO at step S43), the authentication part 92 transmits an unsuccessful result of the authentication to the entry determination part 66. Upon receiving the unsuccessful result of the authentication, the entry determination part 66 transmits the warning signal to the speaker 39 of the entry gate 8 (step S46). When the speaker 39 receives the warning signal, the speaker 39 notifies the user with the warning sound (step S47). In this case, since the enter door 40 does not receive the enter permission signal, the enter door 40 is not opened and the user is not permitted to pass through the door 40.

In both the first operation mode and the second operation mode, the personal authentication process at the time of exit is the same as the first embodiment. Personal authentication using biological authentication may be performed in addition to the personal authentication of the first embodiment.

As described above, according to the second embodiment, even when two types of personal authentication are performed with the tag ID information and the biological information, the personal authentication in the first operation mode is performed so that the user can enter the inside of the management area 3 at the completion of the reading of the tag ID information and the biological information at the time of entry. As a result, the time of the personal authentication at the time of entry can be shortened by the collation time of the tag ID information and the biological information.

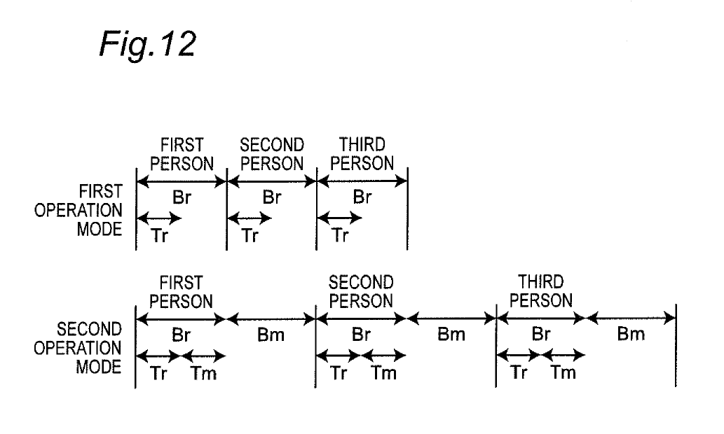

FIG. 12 is a diagram showing a time passage of the personal authentication at the time of entry according to the second embodiment, showing the time required at the time of entry in each of the first operation mode and the second operation mode. In the second operation mode, a reading time Br of the biological information and a collation time Bm of the biological information are required. The reading time Tr and the collation time Tm of the tag ID information are generally shorter than the reading time Br and the collation time Bm, respectively, of the biological information. Therefore, in the case of the first operation mode, the collation time Bm of the biological information and the collation time Tm of the tag ID information are eliminated, so that the time required for each entering person may be substantially only the reading time Br of the biological information.

In the case of mismatching in the collation of the personal information at the time of entry in the first operation mode, the user cannot exit due to the collation of the personal information at the time of exit, so that the position of the user unauthorized to enter can be identified at the time of exit. In this way, the time of personal authentication at the time of entry can be reduced, and the user having entered the inside of the management area 3 without authority can be caught at the exit gate 10.

Additionally, the operation mode of the personal authentication at the entry gate 8 is switched between two types, i.e., the first operation mode and the second operation mode. In the case of the first operation mode, if the authentication with the authentication database 94 is not completed, the user cannot exit from the exit gate 9. However, in the second operation mode, the authentication with the authentication database 94 is completed at the time of entry, so that the user can exit the management area 3 any time. Therefore, by performing the personal authentication in the second operation mode during a non-crowded time, the overall efficiency of entry/exit including the personal authentication at the time of exit is improved by switching between the two authentication operation modes.

### Third Embodiment

An entry/exit management system and an entry/exit management method according to a third embodiment of the present invention will be described. In the entry/exit management system 21 according to the second embodiment, in the case of mismatching of the tag ID information in the collation in the personal authentication in the first operation mode, the location of the user possessing the RFID tag 35 mismatched in the collation can only be identified at the exit gate 10. In the third embodiment, the entry/exit management system 21 of the second embodiment further includes a position identification system identifying a position of a user possessing the RFID tag 35 in the management area 3. In an entry/exit management system 23 according to the third embodiment, the configurations other than the matters described below are the same as the entry/exit management system 21 of the second embodiment.

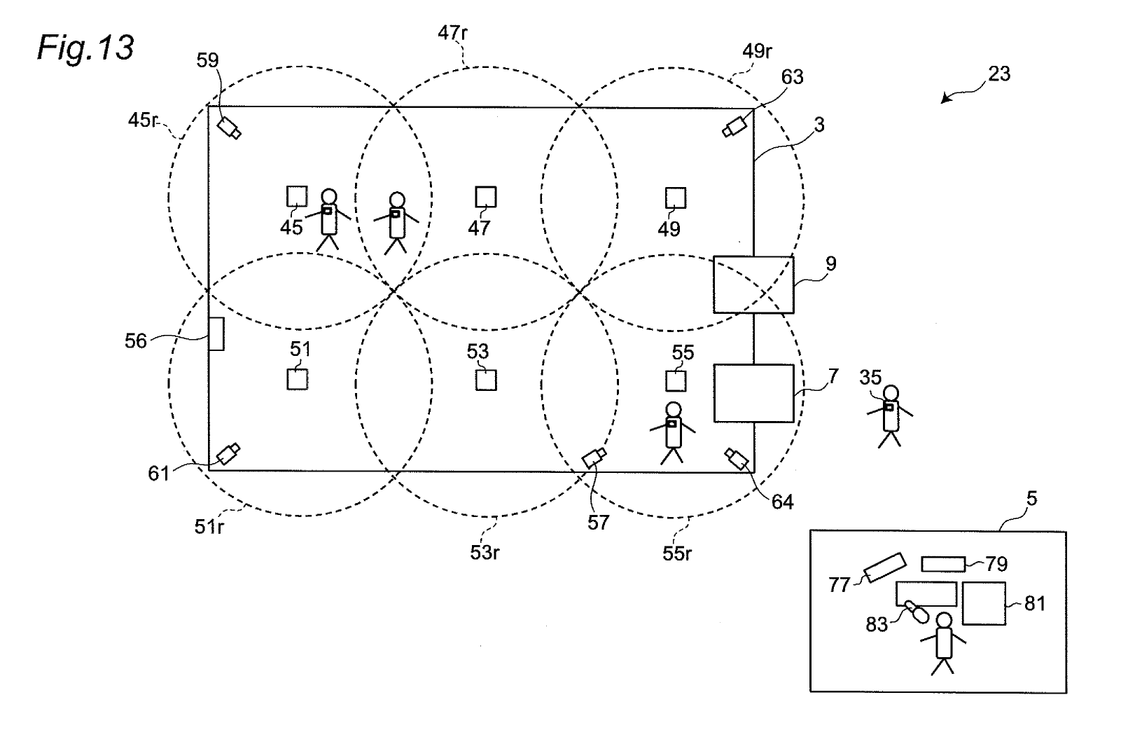

Description will be made with reference to FIG. 13. The readers 45, 47, 49, 51, 53, 55 in the management area 3 are arranged to have respective different reading regions for the tag ID information of the RFID tag 35. Additionally, the readers 45, 47, 49, 51, 53, 55 in the management area 3 are arranged in the management area 3 such that the adjacent readers have partially overlapping reading ranges for the RFID tag 35. For example, a reading range 45r of the reader 45 partially overlaps respective reading ranges 47r, 51r of the readers 47, 51 arranged next to the reader 45. A read range 55r of the reader 55 partially overlaps respective read ranges 49r, 53r of the readers 49, 53 arranged next to the reader 55. With such arrangement, the RFID tag 35 can be detected without omission regardless of where the user is in the management area 3. Each of the readers in the management area 3 reads the RFID tag 35 at a predefined time period. If none of the RFID tags 35 exists within the reading range of the reader and no tag ID information is read by the reader within one period, each of the readers sends nothing as read data to the host computer 81. The reading of each of the readers in the management area 3 is periodically performed at intervals of several seconds. For transfer to the host computer 81, the read data may be transmitted for each of the readers or may be transmitted collectively on the basis of a management area.

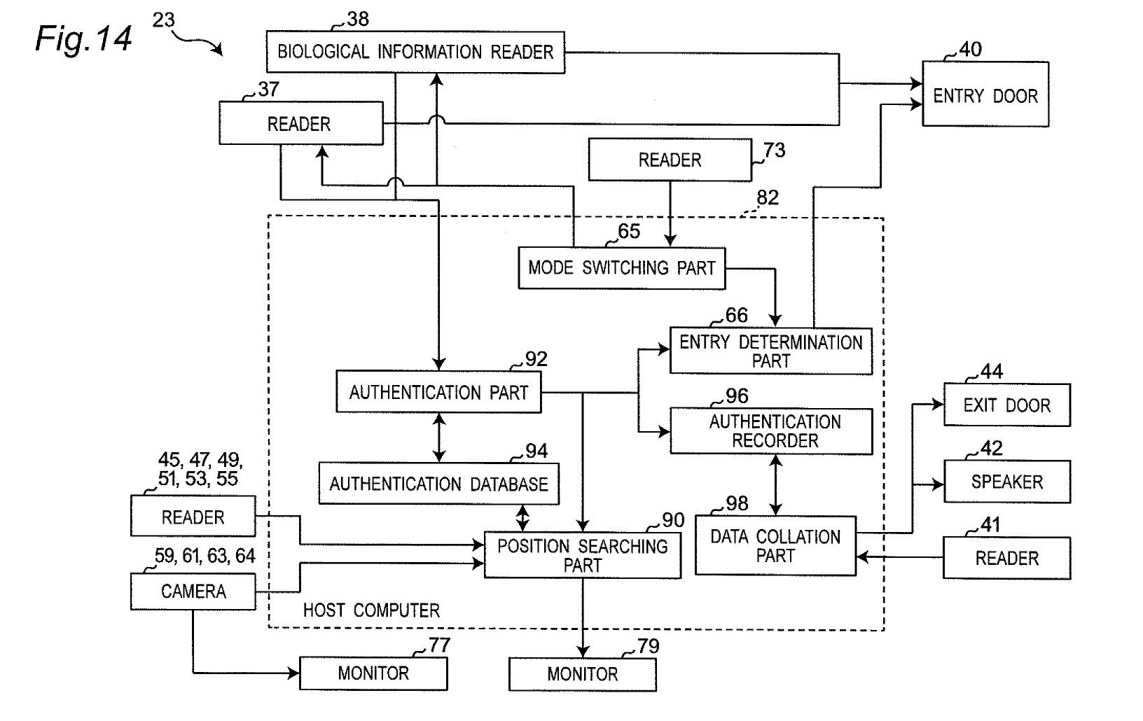

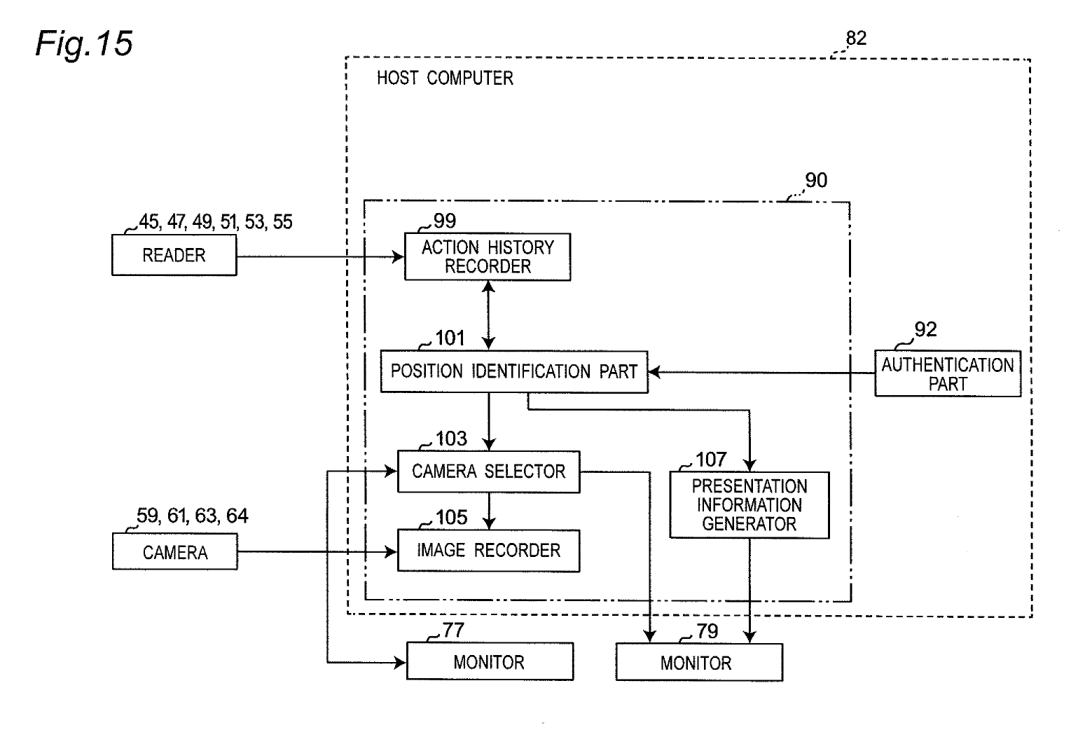

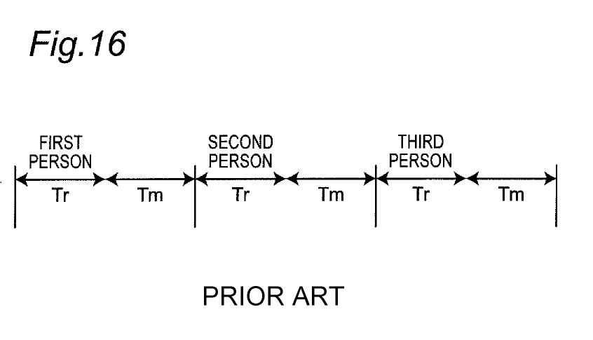

Description will then be made with reference to FIGS. 14 and 15. FIG. 14 is a block diagram showing a schematic configuration of the entry/exit management system according to the third embodiment. FIG. 15 is a schematic configuration diagram of a user position identification system according to the third embodiment. The entry/exit management system 23 according to the third embodiment includes the readers 45, 47, 49, 51, 53, 55, the cameras 59, 61, 63, 64, the monitor 77, 79, and a position searching part 90 in the entry/exit management system according to the second embodiment.

In the management area 3, the readers 45, 47, 49, 51, 53, 55 disposed at various places read the tag ID information of the RFID tag 35 at a predefined time period. If a user is present within the reading range of the reader, the reader reads the tag ID information and transmits the tag ID information together with reader ID information of the reader that has read the information and the reading time to the host computer 82.

In the monitoring room 5, the host computer 82 receives the tag ID information, the reader ID information, and the reading time sent thereto and records these pieces of information in an action history recorder 99. The authentication part 92 transmits the tag ID information mismatched as a result of collation to the position identification part 101.

The position identification part 101 identifies the position of the user in the management area 3 from the reader ID information. Specifically, from the tag ID information and the reader ID information recorded in the action history recorder 99 and the tag ID information mismatched as a result of collation, the position identification part 101 identifies which of the RFID tag detection regions in the management area 3 the user having the mismatched tag ID information is present in. The identified position information is sent to the presentation information generator 107. A presentation information generator 107 generates presentation information showing the identified position information on a sketch map of the management area 3. The generated presentation information is sent to the monitor 79 and displayed. The surveillant can announce the presence of a suspicious person from the speaker 56 in the management area 3 by using the microphone 83 of the monitoring room 5. The surveillant can also inform a security guard of the position in the management area 3 where the user unauthorized to enter is present.

It is noted that the position identification system may be a system using only the RFID tag 35 and the readers described above or may be implemented by employing other systems tracking through image recognition using a plurality of the cameras 59, 61, 63, 64. In the case of tracking through image recognition, the faces of the users passing through the entry gate 7 may be captured one by one by the camera 57 and recorded in an image recorder 105, and the tracking may be performed from a plurality of camera images through image processing based on the captured images. When a corresponding user is found through the image processing, a camera selector 103 may select the camera for capturing and output a captured image to the monitor 79.

The position identification part 101, the camera selector 103, and the presentation information generator 107 may be made up of a plurality of CPUs, microprocessors, or FPGAs or may be integrated with other constituent elements of the host computer 82 into one CPU, microprocessor, or FPGA. The action history recorder 99 and the image recorder 105 may be made up of hard disks, memories, or SSDs. Alternatively, the action history recorder 99 and the image recorder 105 may be integrated with the authentication database 94 and the authentication recorder 96 into one hard disk, memory, or SSD.

As described above, since the user tracking system is included, even in the case of entry after only reading the personal information in the first operation mode, the position of the user with unsuccessful authentication can be identified as soon as the authentication of the personal information is completed. Since the position of the user unauthorized to enter can be identified before exit, the user unauthorized to enter can more quickly be caught.

It should be appreciated that the present invention is not limited to the exemplary embodiments and can be implemented in modifications as follows.

In the second embodiment, a user is allowed to enter after the tag ID information and the biological information are merely read in the first operation mode; however, the present invention is not limited thereto. In the first operation mode, a user may be allowed to enter after the tag ID information is authenticated while the biological information is merely read. In this case, the biological information is authenticated after entry of the user.

The entry/exit management system and the entry/exit management method according to the present invention are useful for management of entry/exit to/from facilities such as factories, banks, hospitals, companies, and data centers.

### EXPLANATIONS OF LETTERS OR NUMERALS

1, 21, 23 entry/exit management system
3 management area
5 monitoring room
7 entry gate
8 entry gate
9 exit gate
10 exit gate
35, 35a, 35b, 35c RFID tag
37 reader
38 biological information reader
39 speaker
40 entry door
41 reader
42 speaker
43 biological information reader
44 exit door
45, 47, 49, 51, 53, 55 reader
56 speaker
57, 59, 61, 63, 64 camera
65 mode switching part
66 entry determination part
67 reader part
69 ID information storage
70 reader part
71 biological information storage
73 reader
77, 79 monitor
81, 82 host computer
83 microphone
90 position searching part
91 authentication part
92 authentication part
93 authentication database
94 authentication database
95 authentication recorder
96 authentication recorder
97 data collation part
98 data collation part
99 action history recorder
100 personal information inquiry part
101 position identification part
103 camera selector
105 image recorder
107 presentation information generator

1. An entry/exit management system for managing entry/exit of a plurality of users in a management area through personal authentication, the system comprising:
an entry gate configured to restrict entry of users into the management area;
a reader disposed at the entry gate and configured to read personal information of each user entering the management area;
a storage configured to record the personal information read by the reader;
a database configured to store in advance personal authentication information for authenticating the plurality of users;
an authenticator configured to authenticate the personal information recorded in the storage by collating the personal information with the personal authentication information stored in the database;
an exit gate configured to restrict exit of users from the management area; and
a controller configured to set a first operation mode for the entry/exit management system in which the reader is configured to read the personal information of each user entering the management area and control the entry gate to permit the entry of the respective users when the personal information is read by the read,
wherein, in the first operation mode and after allowing the entry gate to permit the entry of the respective user to the management area, the authenticator is configured to authenticate the personal information recorded in the storage and control the exit gate to prevent the exit of each respective user until the personal information recorded in the storage is successfully authenticated for that user.

2. The entry/exit management system according to claim 1, wherein the controller is further configured to set a second operation mode for the entry/exit management system in which the entry gate is configured to permit the entry of each of the respective users entering the management area when the personal information read for each respective user is successfully authenticated.

3. The entry/exit management system according to claim 2, wherein the controller of the entry/exit management system is configured to switch between the first operation mode and the second operation mode.

4. The entry/exit management system according to claim 3, wherein the reader disposed at the entry gate is configured to detected a number of the plurality of users standing in line at the entry gate based on the read personal information of each of the respective users.

5. The entry/exit management system according to claim 4, wherein the controller of the entry/exit management system is configured to switch from the second operation mode to the first operation mode when the detected number of the plurality of users standing in line at the entry gate exceeds a predetermined threshold number.

6. The entry/exit management system according to claim 1, further comprising:
a plurality of readers disposed in the management area and configured to read the personal information from respective RFID tags of each of the plurality of users located in the management area; and
a position identification system configured to identify a position of each of the plurality users located in the management area based on the read personal information read by the plurality of readers in the management area.

7. The entry/exit management system according to claim 1, wherein the read personal information is biological information of each respective user, and the reader is a biological information reader.

8. The entry/exit management system according to claim 1, wherein the read personal information is ID information of each respective user, and the reader is an ID reader.

9. The entry/exit management system according to claim 1, wherein the read personal information is biological information and RFID information, and the reader includes a biological information reader and an RFID reader.

10. The entry/exit management system according to claim 1, wherein the recorded personal information is concurrently collated for a plurality of the respective users at a time with the personal authentication information stored in advance in the database.

11. An entry/exit management method for managing entry/exit of a plurality of users in a management area through personal authentication, the method comprising:
reading personal information of each user at an entry gate configured to restrict entry of each respective user into the management area;
recording the read personal information;
authenticating the recorded personal information by collating the recorded personal information with personal authentication information recorded in advance in a database;
setting a first operation mode for the entry/exit management method in which each of the users having the personal information read is then permitted to enter the management area through the entry gate;
in the first operation mode and after permitting a respective user to enter the management area through the entry gate, authenticating the personal information of the respective user in the management area; and
preventing the respective user in the management area from exiting an exit gate of the management area until the personal information of the respective user is successfully authenticated.

12. The entry/exit management method according to claim 11, further comprising setting a second operation mode for the entry/exit management method in which each of the users having the read personal information is permitted to enter the management area through the entry gate when the personal information read for each respective user is successfully authenticated.

13. The entry/exit management method according to claim 12, further comprising switching between the first operation mode and the second operation mode.

14. The entry/exit management method according to claim 13, further comprising detecting, by a reader disposed at the entry gate, a number of the plurality of users standing in line at the entry gate based on the read personal information of each of the respective users.

15. The entry/exit management method according to claim 14, further comprising switching from the second operation mode to the first operation mode when the detected number of the plurality of users standing in line at the entry gate exceeds a predetermined threshold number.

16. The entry/exit management method according to claim 11, further comprising:
reading, by a plurality of readers disposed in the management area, the personal information from respective RFID tags of each of the plurality of user located in the management area; and
identifying, a position of each of the plurality of users in the management area based on the personal information read by the plurality of readers disposed in the management area.

17. The entry/exit management method according to claim 11, wherein the read personal information is biological information of each respective user, and the reading of the personal information comprises reading the biological information of each respective user.

18. The entry/exit management method according to claim 11, wherein the personal read information is ID information of each respective user, and the reading of the personal information comprises reading the ID information of each respective user.

19. The entry/exit management method according to claim 11, wherein the read personal information is biological information and RFID information, and the reading of the personal information comprises reading the biological information and the RFID information of each respective user.

20. The entry/exit management method according to claim 11, further comprising collating the recorded personal information for a plurality of the respective users at a concurrent time with the personal authentication information stored in advance in the database.
